(19) United States
(12) Patent Application Publication
(10) Pub. No.: US 2026/0006214 A1
(43) Pub. Date: Jan. 1, 2026

(54) IMPLICIT GEOMETRIC PARTITIONING FOR VIDEO CODING

(71) Applicant: Alibaba (China) Co., Ltd., Hangzhou (CN)

(72) Inventors: Ke JIA, Beijing (CN); Jie CHEN, Beijing (CN); Xinwei LI, Beijing (CN); Ru-ling LIAO, Sunnyvale, CA (US); Yan YE, San Diego, CA (US)

(21) Appl. No.: 19/250,869

(22) Filed: Jun. 26, 2025

Related U.S. Application Data
(60) Provisional application No. 63/666,624, filed on Jul. 1, 2024.

(51) Int. Cl. H04N 19/14; H04N 19/119; H04N 19/176

(52) U.S. Cl. CPC H04N 19/14; H04N 19/119; H04N 19/176

(57) ABSTRACT

A method for decoding a bitstream includes: receiving a bitstream; and decoding the bitstream to output a video sequence. The decoding including: generating a set of motion pair candidates from refined motion vectors or merge motion vectors under an implicit geometric partitioning mode, in which the refined motion vectors are obtained by template matching; deriving, based on the set of motion pair candidates, at least two blending matrices associated with a coding block; and applying the at least two blending matrices to at least two geometric partition parts of the coding block, respectively.

### CROSS-REFERENCE TO RELATED APPLICATIONS

The present application claims the benefits of priority to U.S. Provisional Application No. 63/666,624, filed on Jul. 1, 2024, which is incorporated herein by reference in its entirety.

### TECHNICAL FIELD

The present disclosure generally relates to video processing, and more particularly, to methods and apparatuses of applying template matching (TM) and merge motion vector differences (MMVD) in implicit geometric partitioning mode (GPM).

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide methods and apparatuses of applying template matching (TM) and merge motion vector differences (MMVD) in implicit geometric partitioning mode (GPM).

According to some embodiments, a method for decoding a bitstream includes: receiving a bitstream; and decoding the bitstream to output a video sequence. The decoding including: generating a set of motion pair candidates from refined motion vectors or merge motion vectors under an implicit geometric partitioning mode, in which the refined motion vectors are obtained by template matching; deriving, based on the set of motion pair candidates, at least two blending matrices associated with a coding block; and applying the at least two blending matrices to at least two geometric partition parts of the coding block, respectively.

According to some embodiments, a method for encoding a video sequence includes: receiving a video sequence; and encoding the video sequence by: determining that an implicit geometric partitioning mode is applied to a coding block; generating a set of motion pair candidates from refined motion vectors or merge motion vectors under an implicit geometric partitioning mode, in which the refined motion vectors are obtained by template matching; deriving, based on the set of motion pair candidates, at least two blending matrices associated with the coding block; applying the at least two blending matrices to at least two geometric partition parts of the coding block, respectively; and encoding the at least two geometric partition parts.

According to some embodiments, a method of storing a bitstream includes: determining that an implicit geometric partitioning mode is applied to a coding block; generating a set of motion pair candidates from refined motion vectors or merge motion vectors under an implicit geometric partitioning mode, in which the refined motion vectors are obtained by template matching; deriving, based on the set of motion pair candidates, at least two blending matrices associated with the coding block; applying the at least two blending matrices to at least two geometric partition parts of the coding block, respectively; generating a bitstream comprising coded information associated with the at least two geometric partition parts; and storing the bitstream in a non-transitory computer readable storage medium.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2 is a schematic diagram illustrating an exemplary encoding process of a hybrid video coding system, according to some embodiments of the present disclosure.

FIG. 3 is a schematic diagram illustrating an exemplary decoding process of a hybrid video coding system, according to some embodiments of the present disclosure.

FIG. 4 is a block diagram of an exemplary apparatus for encoding or decoding a video, according to some embodiments of the present disclosure.

FIG. 5 is a schematic diagram illustrating examples of the GPM splits grouped by identical angles, according to some embodiments of the present disclosure.

FIG. 6 is a schematic diagram illustrating exemplary generation of a bending weight using geometric partitioning mode, according to some embodiments of the present disclosure.

FIG. 7 is a schematic diagram illustrating a ramp function for the weights for GPM blending based on the displacement (d) from a predicted sample position to the GPM partitioning boundary and the blending area size (t), according to some embodiments of the present disclosure.

FIG. 8 is a schematic diagram illustrating an exemplary edge of reference templates where GPM partition is applied, according to some embodiments of the present disclosure.

FIGS. 9A-9C are schematic diagrams illustrating example intra prediction mode (IPM) candidates used for GPM with intra and intra prediction, according to some embodiments of the present disclosure.

FIG. 9D is a schematic diagram illustrating an example GPM with intra and intra prediction, according to some embodiments of the present disclosure.

FIG. 10 is a flowchart for an example method for decoding a bitstream, according to some embodiments of the present disclosure.

FIG. 11 is a flowchart for an example method for decoding a bitstream, according to some embodiments of the present disclosure.

FIG. 12 is a flowchart for another example method for decoding a bitstream, according to some embodiments of the present disclosure.

FIG. 13 is a flowchart for an example method for decoding a bitstream, according to some embodiments of the present disclosure.

FIG. 14 is a flowchart for another example method for decoding a bitstream, according to some embodiments of the present disclosure.

FIG. 15 is a flowchart for another example method for decoding a bitstream, according to some embodiments of the present disclosure.

FIG. 16 is a flowchart for another example method for decoding a bitstream, according to some embodiments of the present disclosure.

FIG. 17 is a flowchart for another example method for decoding a bitstream, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) are currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve this goal, since 2015, the JVET has been developing technologies beyond HEVC using the joint exploration model (JEM) reference software. As coding technologies being incorporated into the JEM, the JEM achieved substantially higher coding performance than HEVC. In October 2017, a joint call for proposals (CfP) was issued by VCEG and MPEG to formally start the development of next generation video compression standard beyond HEVC. Responses to the CfP were evaluated at the JVET meeting in San Diego in April 2018, and the formal development process of the VVC standard started in April 2018.

The VVC standard has been progressing well since April 2018, and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

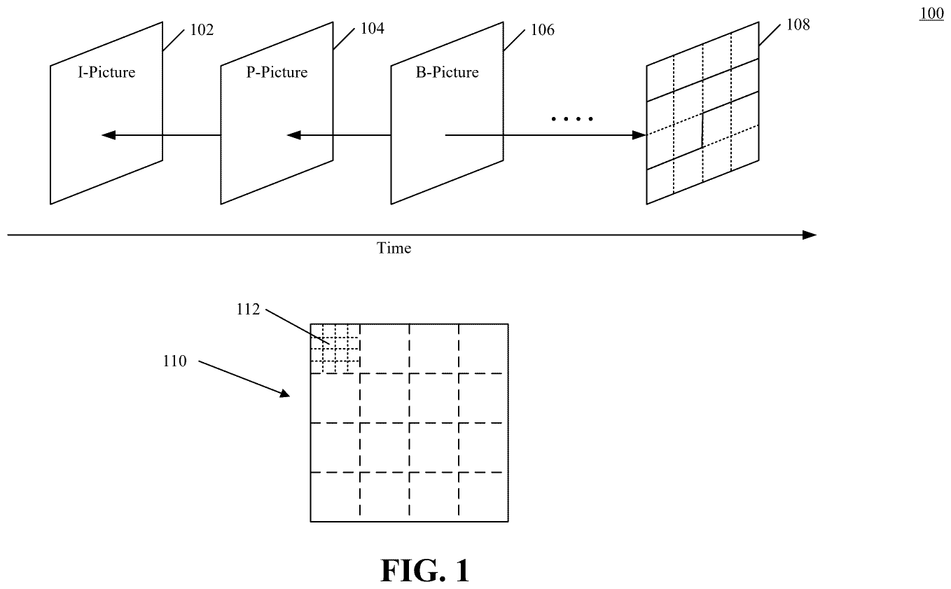

FIG. 1 illustrates structures of an example video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units 112, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

As shown in FIG. 1, basic processing unit 112 in structure 110 is further partitioned into 4×4 basic processing sub-units. For example, in AVS3, a CTU may be further partitioned into coding units (CUs) using quad-tree, binary tree, or extended binary tree. The basic processing sub-units in FIG. 1 is for illustrative purpose only. Different basic processing units of the same picture can be partitioned into basic processing sub-units in different schemes. The basic processing sub-units can be referred to as “coding units” (“CUs”) in some video coding standards (e.g., AVS3, H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

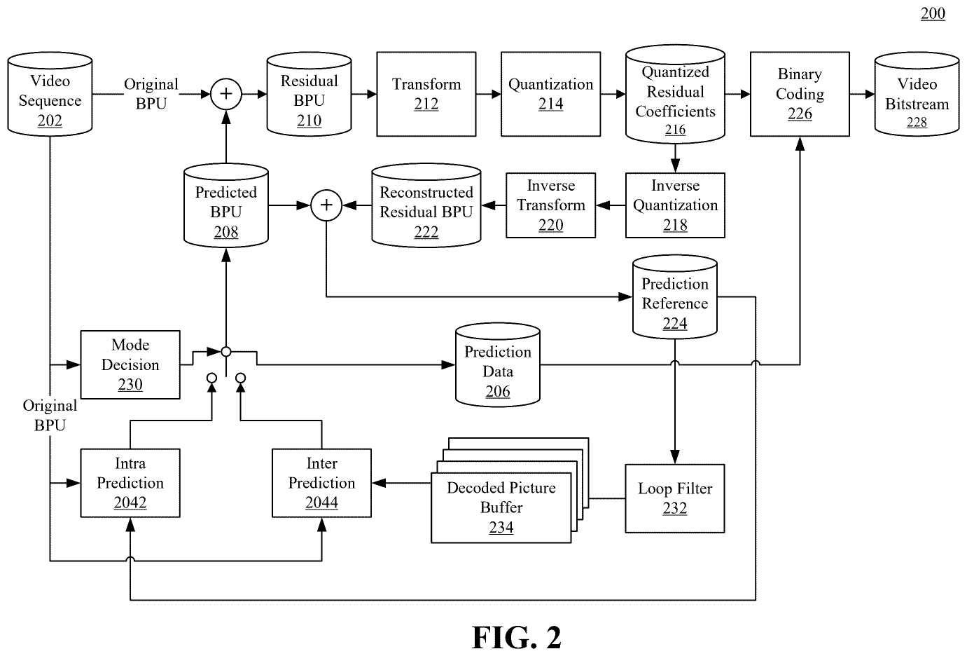

FIG. 2 illustrates a schematic diagram of an exemplary encoder 200 in a video coding system, (e.g., AVS3 or H.26x series), consistent with some embodiments of the present disclosure. The input video is processed block by block. As discussed above, in the AVS3 standard, a CTU is the largest block unit and can be as large as 128×128 luma samples (plus the corresponding chroma samples depending on the chroma format). One CTU may be further partitioned into CUs using quad-tree, binary tree, or ternary tree. Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Similar to video sequence 100 in FIG. 1, video sequence 202 can include a set of pictures (referred to as “original pictures”) arranged in a temporal order. Similar to structure 110 in FIG. 1, any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. In some embodiments, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture.

In some embodiments, an inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2042, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. Encoder 200 can record the direction and distance of such a motion as a “motion vector (MV).” When multiple reference pictures are used (e.g., as picture 106 in FIG. 1), encoder 200 can search for a matching region and determine its associated MV for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, MVs associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the MV) and prediction reference 224. For example, encoder 200 can move the matching region of the reference picture according to the MV, in which encoder 200 can predict the original BPU of the current picture. When multiple reference pictures are used (e.g., as picture 106 in FIG. 1), encoder 200 can move the matching regions of the reference pictures according to the respective MVs and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction and be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. In uni-prediction, only one MV pointing to one reference picture is used to generate the prediction signal for the current block.

On the other hand, bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at opposite temporal directions with respect to picture 104. In bi-prediction, two MVs, each pointing to its own reference picture, are used to generate the prediction signal of the current block. After video bitstream 228 is generated, MVs and reference indices can be sent in video bitstream 228 to a decoder, to identify where the prediction signal(s) of the current block come from.

For inter-predicted CUs, motion parameters may include MVs, reference picture indices and reference picture list usage index, or other additional information needed for coding features to be used. Motion parameters can be signaled in an explicit or implicit manner. In AVS3, under some specific inter coding modes, such as a skip mode or a direct mode, motion parameters (e.g., MV delta and reference picture index) are not coded and signaled in video bitstream 228. Instead, the motion parameters can be derived at the decoder side with the same rule as defined in encoder 200. Details of the skip mode and the direct mode will be discussed in the paragraphs below.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

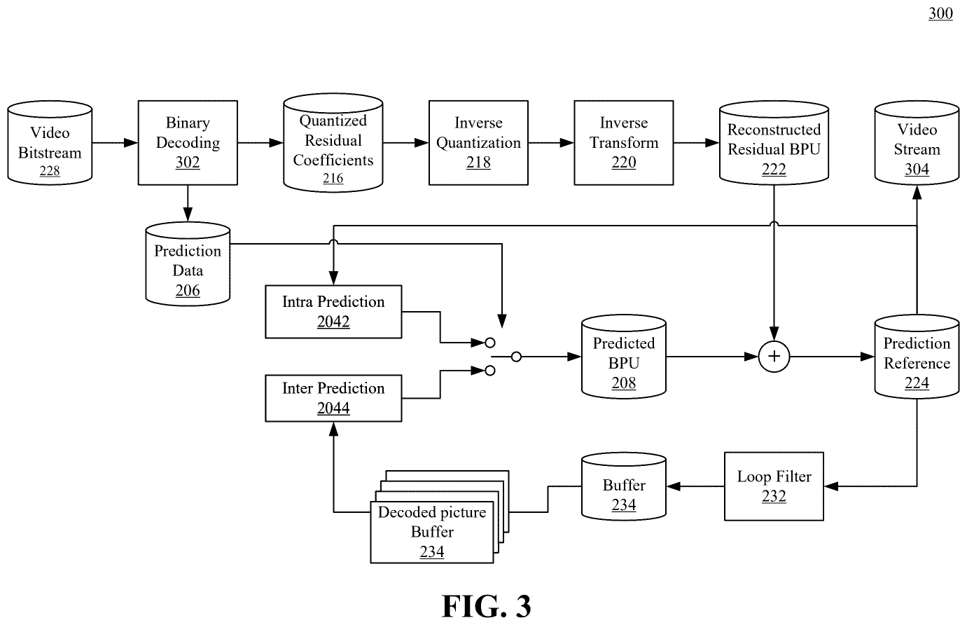

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate prediction reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, both transform and transform skip residual coefficients are coded within non-overlapped CGs. That is, each CG may include one or more transform residual coefficients, or one or more transform skip residual coefficients.

FIG. 3 illustrates a block diagram of an exemplary decoder 300 of a video coding system (e.g., H.26x series), consistent with some embodiments of the present disclosure. Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may be not identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228.

Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302.

Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more MVs respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate prediction reference 224. In some embodiments, prediction reference 224 can be stored in a buffer (e.g., a decoded picture buffer in a computer memory). Decoder 300 can feed prediction reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users.

Decoder 300 can perform the decoding process iteratively to decode each encoded BPU of the encoded picture and generate prediction reference 224 for encoding the next encoded BPU of the encoded picture. After decoding all encoded BPUs of the encoded picture, decoder 300 can output the picture to video stream 304 for display and proceed to decode the next encoded picture in video bitstream 228.

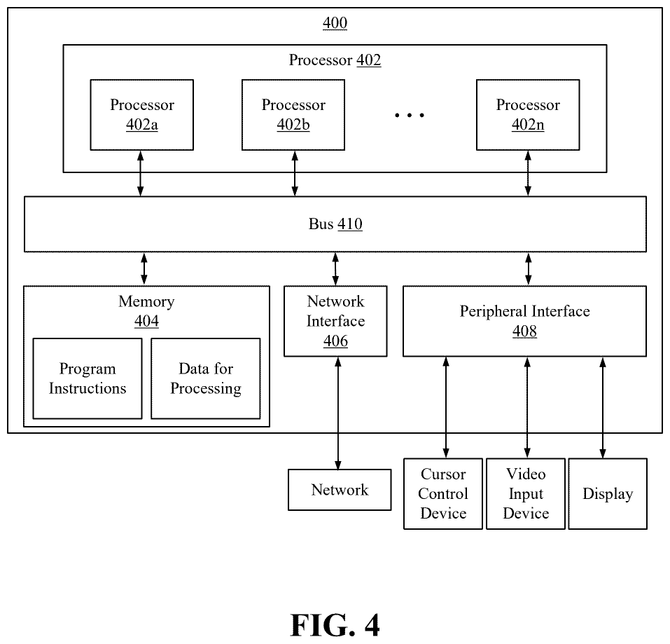

FIG. 4 is a block diagram of an example apparatus 400 for encoding or decoding image data, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes in the encoder 200 or the decoder 300) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processors 402a-402n and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process in the encoder 200 or the decoder 300) can be implemented as any combination of any software or hardware modules in apparatus 400. For example, some or all stages of process in the encoder 200 or the decoder 300 can be implemented as one or more software modules of apparatus 400, such as program instructions that can be loaded into memory 404. For another example, some or all stages of process in the encoder 200 or the decoder 300 can be implemented as one or more hardware modules of apparatus 400, such as a specialized data processing circuit (e.g., an FPGA, an ASIC, an NPU, or the like).

In July 2020, the first version of VVC standard is finalized and is published as an international standard. Afterward, the JVET starts exploring new coding tools to further improve the coding performance of the VVC standard. In January 2021, the Enhanced Compression Model (ECM) has been proposed and used as new software base for developing tools beyond the VVC standard.

In VVC, a mode called Geometric partitioning mode (GPM) is supported. In the GPM mode, a geometric partitioning mode is supported for inter prediction. The geometric partitioning mode is signaled using a CU-level flag as one kind of merge mode, with other merge modes including the regular merge mode, the merge motion vector differences (MMVD) mode, the Combined Inter-Intra Prediction (CIIP) mode and the subblock merge mode. In total 64 partitions are supported by geometric partitioning mode for each possible CU size with excluding 8×64 and 64×8.

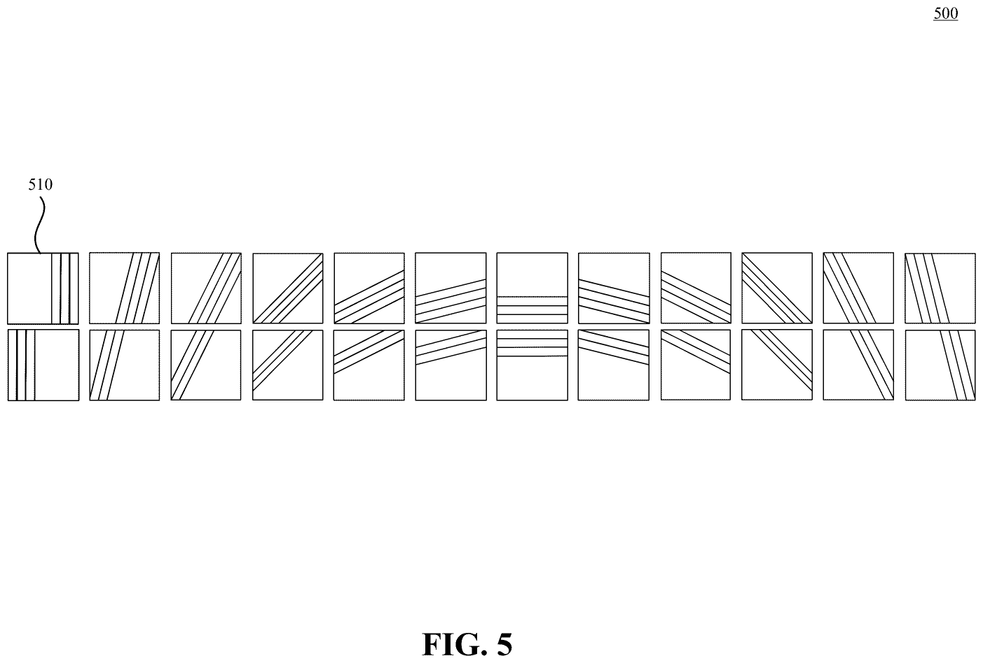

FIG. 5 is a schematic diagram 500 illustrating examples of the GPM splits grouped by identical angles, according to some embodiments of the present disclosure. As shown in FIG. 5, when GPM mode is used, a CU 510 is split into two parts by a geometrically located straight line. The location of the splitting line is mathematically derived from the angle and offset parameters of a specific partition. Each part of a geometric partition in the CU is predicted using its own motion. FIG. 5 illustrates a number of examples of the GPM splits grouped by identical angles.

If geometric partitioning mode is used for the current CU, then a geometric partition index indicating the partition mode of the geometric partition (e.g., angle and offset), and two merge indices (one for each partition) are further signaled. The number of maximum GPM candidate size is signaled explicitly in a Sequence Parameter Set (SPS) and specifies syntax binarization for GPM merge indices. After predicting each part of the geometric partition, the sample values along the geometric partition edge are adjusted using a blending processing with adaptive weights. This is the prediction signal for the whole CU, and transform and quantization process will be applied to the whole CU as in other prediction modes.

Next, motion field storage used for the geometric partitioning mode is described. In VVC, Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) \text{:} partIdx ) \qquad ( Equation 1 )$$

where motionIdx is equal to d(4x+2, 4y+2), which is recalculated from Equation 2 below. The partIdx depends on the angle index i.

If sType is equal to 0 or 1, Mv0 or Mv1 are stored in the corresponding motion field. Otherwise, if sType is equal to 2, a combined Mv from Mv0 and Mv2 are stored. The combined Mv can be generated using the following process. First, if Mv1 and Mv2 are from different reference picture lists (one from L0 and the other from L1), then Mv1 and Mv2 are simply combined to form the bi-prediction motion vectors. Otherwise, if Mv1 and Mv2 are from the same list, only uni-prediction motion Mv2 is stored.

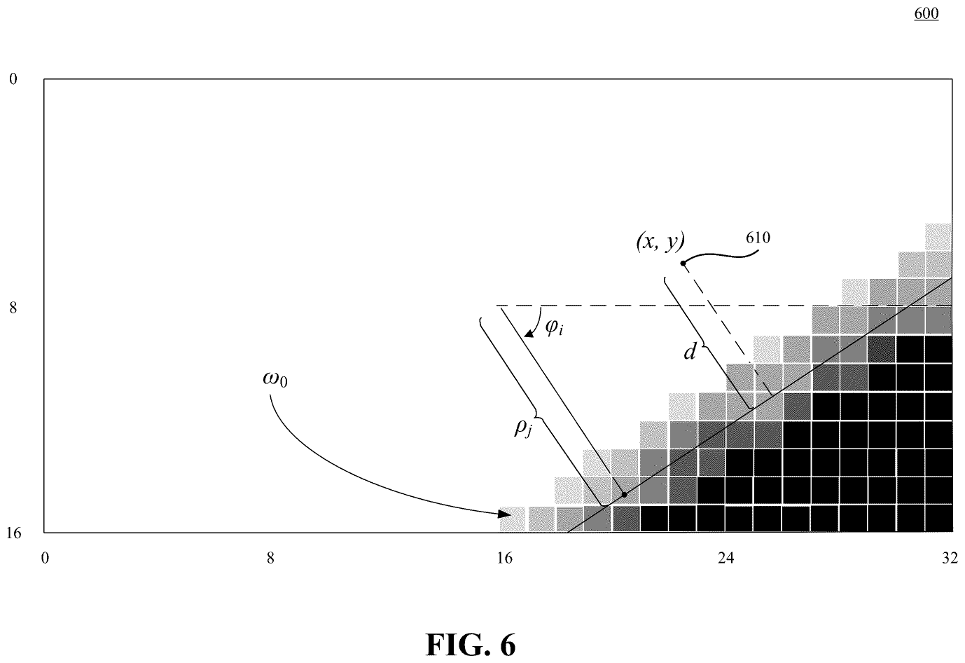

Next, blending along the geometric partitioning edge is described. In VVC, after predicting each part of a geometric partition using its own motion, blending is applied to the two prediction signals to derive samples around geometric partition edge. FIG. 6 is a schematic diagram 600 illustrating exemplary generation of a bending weight using geometric partitioning mode, according to some embodiments of the present disclosure. One example of weigh w₀ is illustrated in FIG. 6. In some embodiments, the blending weight for each position of the CU is derived based on the distance between individual position and the partition edge. The distance for a position 610 (x, y) to the partition edge can be derived as:

$$d ( x , y ) = ( 2 x + 1 - w ) cos ( {φ}_{i} ) + ( 2 y + 1 - h ) sin ( {φ}_{i} ) - {ρ}_{j} \qquad ( Equation 2 )$$

$${ρ}_{j} = {ρ}_{x , j} cos ( {φ}_{i} ) + {ρ}_{y , j} sin ( {φ}_{i} ) \qquad ( Equation 3 )$$

$${ρ}_{x , j} = \{ \begin{matrix}0 & i \% 16 = 8 or ( i \% 16 \neq 0 and h \geq w ) \\ \pm ( j \times w ) >> 2 & otherwise\end{matrix} \qquad ( Equation 4 )$$

$${ρ}_{y , j} = \{ \begin{matrix}\pm ( j \times h ) >> 2 & i \% 16 = 8 or ( i \% 16 \neq 0 and h \geq w ) \\ 0 & otherwise\end{matrix} \qquad ( Equation 5 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as:

$$wIdxL ( x , y ) = partIdx ? 32 + d ( x , y ) \text{:} 32 - d ( x , y ) \qquad ( Equation 6 )$$

$${w}_{0} ( x , y ) = \frac{Clip 3 ( 0 , 8 , ( wIdxL ( x , y ) + 4 ) >> 3 )}{8} \qquad ( Equation 7 )$$

$${w}_{1} ( x , y ) = 1 - {w}_{0} ( x , y ) \qquad ( Equation 8 )$$

where the partIdx depends on the angle index i.

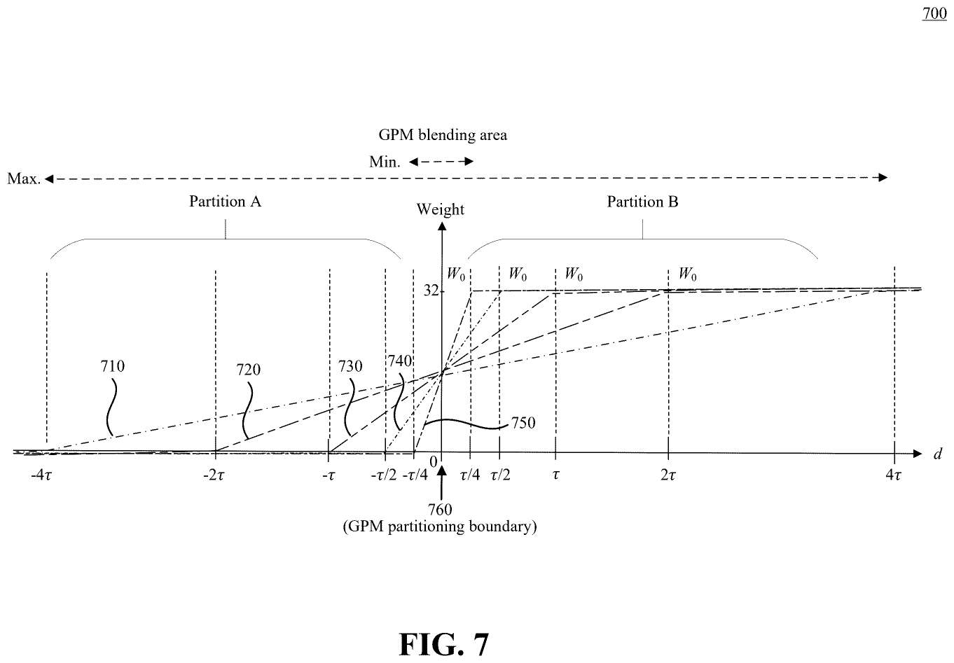

Next, GPM adaptive blending is described. In VVC, the final prediction samples are generated by blending the prediction of the two prediction signals using weighted average. Two integer blending matrices (W0 and W1) are used. The weights in the GPM blending matrices are derived from the ramp function based on the displacement from a predicted sample position to the GPM partitioning boundary. The blending area size is fixed to two (2 samples on each side of the GPM partition split boundary). FIG. 7 is a schematic diagram 700 illustrating a ramp function for the weights for GPM blending, according to some embodiments of the present disclosure. As shown in FIG. 7, the ramp function for the weights is based on the displacement (d) from a predicted sample position to the GPM partitioning boundary 760 and the blending area size (τ), according to some embodiments of the present disclosure.

In ECM, adaptive blending is adopted for GPM mode. Specifically, besides the existing blending area, extra blending area sizes, e.g., quarter (τ/4), half (τ/2), double (2τ), and quadrupole (4τ) of the existing area size (τ), are added for the GPM mode, as shown in lines 710, 720, 730, 740, and 750 in FIG. 7. The selected blending area size is signaled at CU-level from encoder to decoder. Furthermore, the extended weighting precision is proposed, that is the maximum value of the weighs is changed from 8 to 32 to accommodate the extended blending area sizes.

The weights for a geometric partition and the prediction pixel are derived as the following:

$$w ( x , y ) = \{ \begin{matrix}0 & d ( x , y ) \leq - {α}_{i} τ \\ \frac{32}{( 2 {α}_{i} τ ) ( d ( x , y ) + {α}_{i} τ )} & - {α}_{i} τ \leq d ( x , y ) \leq {α}_{i} τ \\ 32 & d ( x , y ) \geq {α}_{i} τ\end{matrix} \qquad ( Equation 9 )$$

$$p ( x , y ) = ( w ( x , y ) * A ( x , y ) + ( 32 - w ( x , y ) ) * B ( x , y ) + 16 ) >> 5 \qquad ( Equation 10 )$$

where A(x, y) and B(x, y) represent the prediction sample values at the coordinate (x, y) within the block referred by MV0 and MV1 prediction.

Next, template matching based reordering for GPM split modes is described. In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode located in the reordering list is signaled.

The reordering method for GPM split modes is a two-step process performed after the respective reference templates of the two GPM partitions in a coding unit are generated, as follows. First, GPM partition edge is extended into the reference templates of the two GPM partitions, resulting in 64 reference templates and the respective TM cost is computed for each of the 64 reference templates. Second, GPM split modes are reordered based on their TM cost values in ascending order and marking the best 32 split modes as available split modes.

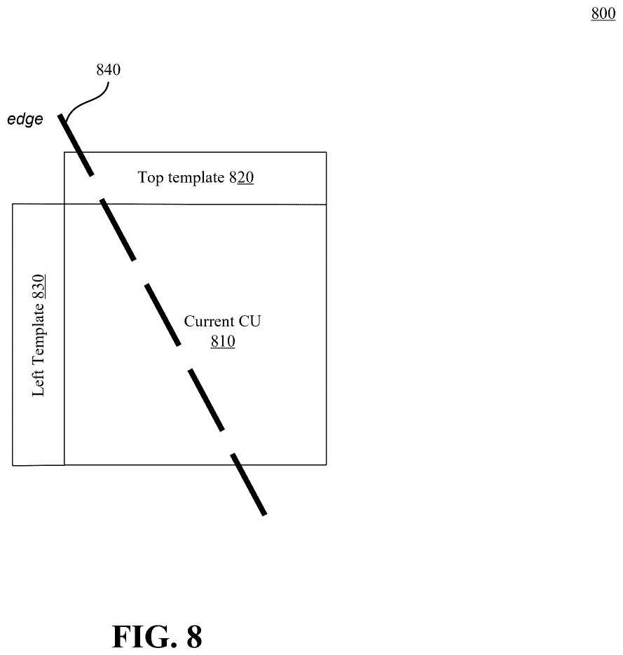

FIG. 8 is a schematic diagram 800 illustrating an exemplary edge of reference templates where GPM partition is applied, according to some embodiments of the present disclosure. As illustrated in FIG. 8, above the current CU 810, a top template 820 can constructed using above neighboring samples. Similarly, a left template 830 can constructed using left neighboring samples. The edge 840 on the template can be extended from that of the current CU 810, but GPM blending process is not used in the template area across the edge.

After ascending reordering using TM cost, an index is signaled. In some embodiments, after ascending reordering using TM cost, an index is signaled using Golomb-Rice code (e.g., with divisor 4) to indicate the use of GPM split mode. Table 1 below shows the binary code of each index.

TABLE 1
Binary code for GPM index

Binary code

| Index | Prefix | Suffix |
|---|---|---|
| 0-3 | 0 | 00-11 |
| 4-7 | 10 | 00-11 |
| 8-11 | 110 | 00-11 |
| . . . | . . . | . . . |
| 28-31 | 1111 111 | 00-11 |

Next, geometric partitioning mode (GPM) with template matching (TM) is described. In some embodiments, template matching can be applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 2, where A represents using above samples, L represents using left samples, and L+A represents using both left and above samples. The motion is then refined by minimizing the difference between the current template and the template in the reference picture using the same search pattern of merge mode with half-pel interpolation filter disabled.

TABLE 2
Example template for the 1st and 2nd geometric partitions

| Partition angle | 0 | 2 | 3 | 4 | 5 | 8 | 11 | 12 | 13 | 14 |
|---|---|---|---|---|---|---|---|---|---|---|
| 1^{st} partition | A | A | A | A | L + A | L + A | L + A | L + A | A | A |
| 2^{nd} partition | L + A | L + A | L + A | L | L | L | L | L + A | L + A | L + A |
| Partition angle | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

In some embodiments, a GPM candidate list is constructed as follows. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates. Zero MV candidates are padded until the GPM candidate list is full.

The GPM-MMVD and GPM-TM are exclusively enabled to one GPM CU. This is done by first signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

Next, geometric partitioning mode (GPM) with merge motion vector differences (MMVD) is described. GPM in VVC is extended by applying motion vector refinement on top of the existing GPM uni-directional MVs. A flag is first signaled for a GPM CU, to specify whether this mode is used. If the mode is used, each geometric partition of a GPM CU can further decide whether to signal MVD or not. If MVD is signaled for a geometric partition, after a GPM merge candidate is selected, the motion of the partition is further refined by the signaled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

Next, bi-predictive GPM is described. The GPM design in VVC relies on uni-predictive motion vectors to generate motion compensated prediction samples for each inter GPM partition. In ECM, such a design has been extended to allow usage of bi-predictive motion vectors.

When constructing a GPM candidate list, the extraction process that extracts uni-predictive motion vectors from the initial merge list is invoked only for small blocks 8×8, 16×8 and 8×16. For larger blocks, the extraction process is bypassed, so the initial merge list (which may contain merged Bi-MVs) is directly used as the final GPM merge list. The generation of the initial merge list is the same as before (i.e., the normal merge list generation without any candidate reordering) except that when generating the initial merge list for larger blocks (i.e., blocks with the extraction process bypassed), the motion vector difference threshold for controlling whether a candidate can be added into the list is increased to be one full sample distance.

In some embodiment, bi-directional optical flow (BDOF) based motion vector refinement as in the multi-pass DMVR is used when generating motion compensated prediction samples.

When GPM-MMVD is used for a GPM partition and its base motion vector is bi-predictive, for low-delay pictures, the signaled MVD is applied on top of the L0 and L1 motion vector as in the existing merge MMVD design. For non-low-delay pictures, the bi-predictive motion vector is converted into a uni-predictive motion vector first and then the MVD is applied on top.

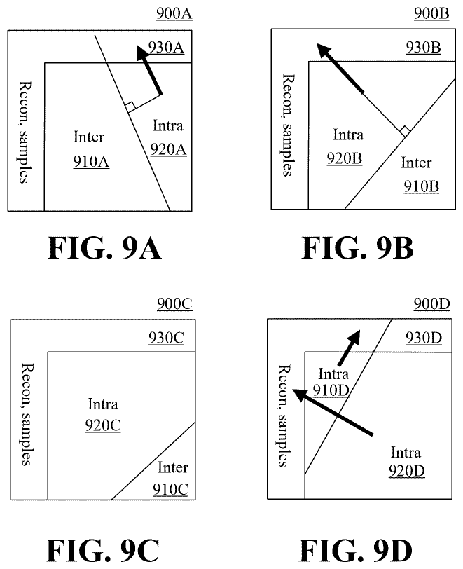

Next, GPM with inter and intra prediction is described. In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. In some embodiments, the IPM candidate list size is pre-defined as 3. FIGS. 9A-9C are schematic diagrams illustrating available IPM candidate 900A, 900B, and 900C for the GPM. As shown in FIGS. 9A-9C, a CU is split into a first part (e.g., 910A, 910B, and 910C) for inter prediction and a second part (e.g., 920A, 920B, and 920C) for intra prediction, with reconstruction samples (e.g., 930A, 930B, and 930C) on the left and top of the current block. Specifically, FIG. 9A shows an example parallel angular mode against the GPM block boundary (i.e., parallel mode), according to some embodiments of the present disclosure. FIG. 9B shows an example perpendicular angular mode against the GPM block boundary (i.e., perpendicular mode), according to some embodiments of the present disclosure. FIG. 9C shows an example planar mode, according to some embodiments of the present disclosure. FIG. 9D is a schematic diagram illustrating an example GPM 900D with intra and intra prediction, according to some embodiments of the present disclosure. As shown in FIG. 9D, a CU is split into two parts 910D and 920D for intra prediction, with reconstruction samples 930D on the left and top of the current block. Furthermore, GPM with intra and intra prediction as shown FIG. 9D is restricted to reducing the signaling overhead for IPMs and avoiding an increase in the size of the intra prediction circuit on the hardware decoder. In addition, a direct motion vector and IPM storage on the GPM-blending area is introduced to further improve the coding performance.

In some embodiments, in decoder-side intra mode derivation (DIMD) and neighboring mode based IPM derivation, the parallel mode is registered first. Therefore, max two IPM candidates derived from the DIMD method and/or the neighboring blocks can be registered if there is not the same IPM candidate in the list. In some embodiments, as for the neighboring mode derivation, there are five positions for available neighboring blocks at most, but they are restricted by the angle of GPM block boundary as shown in Table 3 below, which are already used for GPM with template matching (GPM-TM). In Table 3, A and L respectively denote the above and left side of the prediction block.

TABLE 3
Example positions of available neighboring blocks for IPM candidate
derivation based on the angle of GPM block boundary.

| Angle of GPM | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

In some embodiments, GPM-intra can be combined with GPM with motion vector difference (GPM-MMVD). Template-based Intra Mode Derivation (TIMD) can be used for IPM candidates of GPM-intra to further improve the coding performance. The parallel mode can be registered first, then IPM candidates of TIMD, DIMD, and neighboring blocks.

Consistent with some disclosed embodiments, in the implicit GPM, the two integer blending matrices W0 and W1 can be derived from the template (1 line above, 1 column left). The blending matrices are modelled as an affine linear function of the sample positions (x, y) in the current CU as follows:

$$W 0 ( x , y ) = a . x + b . y + c \qquad ( Equation 11 )$$

$$W 1 ( x , y ) = 1 - W 0 ( x , y ) \qquad ( Equation 12 )$$

The parameters (a, b, c) are derived from the reference template using the same solver (MSE minimization) as the one used for Convolutional Cross-Component Model (CCCM), Gradient Linear Model (GLM) or Gradient and Location Based Convolutional Cross-Component Model (GL-CCCM). A list of motion pair candidates is built from the regular GPM candidates and re-ordered with the template cost.

The implicit GPM mode is signaled by a CU-level flag (e.g., gpm_implicit_flag). If gpm_implicit_flag is true, a merge-index is coded to signal the pair of GPM candidates to be used. If gpm_implicit_flag is false, the regular GPM syntax elements are signaled.

Next, affine motion compensation combined with geometric partition mode (AMC-GPM) is described. In ECM, the GPM is further extended to enable affine motion compensation (AMC). Therefore, a GPM partition can be predicted by AMC inter-prediction, non-AMC inter-prediction or intra-prediction. In addition, a GPM partition predicted by AMC can be combined with the other GPM partition predicted by AMC, non-AMC, or intra-prediction.

When AMC is applied, a uni-prediction affine merge candidate list is constructed from the subblock-based merge candidate list after discarding sub-TMVP candidates, similar to the uni-prediction merge candidate list construction for GPM in VVC. AMC is performed for a GPM partition using the control point motion vectors (CPMVs) of a merge candidate in the uni-prediction affine merge candidate list. The length of the uni-prediction affine merge candidate list is signaled in SPS. When ARMC is applicable, the uni-prediction affine merge candidate list is reordered according to the template costs.

A gpm_affine_flag is signaled for each GPM partition to indicate whether AMC is applied for the GPM partition. A merge candidate index for the GPM partition is signaled using individual arithmetic context models depending on whether AMC or non-AMC is applied.

In some embodiments, AMC is not allowed for GPM-MMVD and GPM-TM.

Embodiments of the present disclosure propose improvement for implicit GPM to address the following problems. Specifically, in the current design, Template Matching (TM) and Merge Motion Vector Differences (MMVD) have applied to Geometric Partitioning Mode (GPM). When GPM mode is enabled for a CU, the motion vectors can be refined by TM or MMVD or neither of them. However, current implicit GPM mode does not support TM and MMVD applications. When implicit GPM mode is enabled for a CU, the motion vectors cannot be refined by TM and MMVD, which leads to the low accuracy of inter prediction.

In an example current design, the implicit GPM is signaled by a CU-level flag (gpm_implicit_flag). If gpm_implicit_flag is true, a list of motion pair candidates is built from the merge motion candidates and re-ordered with the template cost. The motion pair candidate in the list indicates the motion vectors of two geometric partitions (i.e., the first motion in the motion pair candidate indicating the motion of the first partition, the second motion in the motion pair candidate indicating the motion of the second partition). A merge-index is signaled to indicate which motion pair candidate in the candidate list is used. Then the two integer blending matrices of the pair (W0 and W1) are derived from the template (1 line above, 1 column left). Finally, after each geometric partition part is predicted using its own motion, weighted blending is applied to the two predictions.

In the following embodiments, the improvements for implicit GPM will be described for solving one or more of the above-described problems.

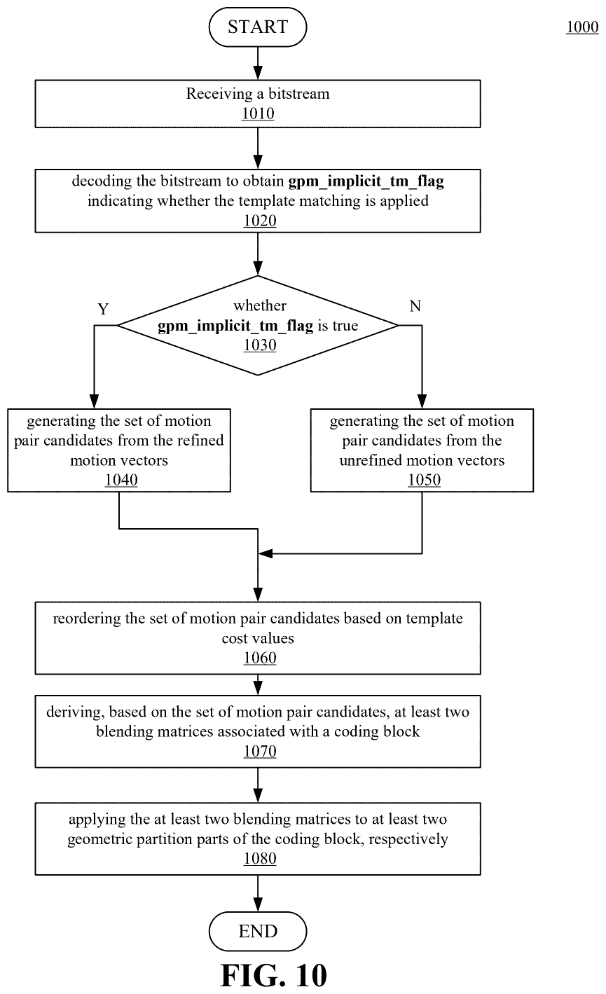

In some embodiments, the template matching (TM) is applied to implicit GPM. In some embodiments, the TM mode of implicit GPM is designed as an explicit mode, and the template used to refine motion vectors includes both above and left neighboring samples. FIG. 10 is a flowchart for an example method 1000 for decoding a bitstream, according to some embodiments of the present disclosure. The method 1000 can be performed by a decoder (e.g., decoder 300 in FIG. 3) to decode video bitstream 228 in FIG. 3. For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the method 1000. As shown in FIG. 10, the method 1000 includes the following steps 1010-1080.

At step 1010, the decoder receives a bitstream (e.g., video bitstream 228 in FIG. 3). The bitstream received from the encoder side includes one or more CUs of a video frame.

In steps 1020-1080, after receiving the bitstream, the decoder may decode the bitstream to output a video sequence (e.g., video stream 304 in FIG. 3). At step 1020, after receiving the bitstream, the decoder may decode the bitstream to obtain a flag (e.g., gpm_implicit_tm_flag) indicating whether the template matching is applied. In some embodiments, when the implicit GPM mode is chosen, a CU-level flag (e.g., gpm_implicit_tm_flag) is signaled to indicate whether TM is applied to both geometric partitions.

At step 1030, the decoder determines whether TM is applied to both geometric partitions in the coding block. Then, at step 1040 or 1050, the decoder generates a set of motion pair candidates from refined motion vectors or merge motion vectors under an implicit geometric partitioning mode.

Specifically, in response to TM being applied to both geometric partitions (step 1030—Yes), gpm_implicit_tm_flag is true, the decoder performs step 1040 to generate the set of motion pair candidates from the refined motion vectors obtained by template matching. In some embodiments, a template can be constructed by using left and above neighboring samples. The motion vector is then refined by minimizing the difference between the current template and the template in the reference picture using the same search pattern of merge mode with half-pel interpolation filter disabled. Then, the list of motion pair candidates can be built from the TM-refined motion candidates instead of merge motion candidates. The subsequent steps are the same as the original implicit GPM method. In response to gpm_implicit_tm_flag being false (step 1030—No), the decoder performs step 1050 to generate the set of motion pair candidates from the unrefined motion vectors (i.e., merge motion vectors).

After the set of motion pair candidates is generated in step 1040 or 1050, at step 1060, the decoder reorders the set of motion pair candidates based on template cost values associated with the motion pair candidates. As described above, the list of motion pair candidates can be re-ordered with the template cost, and a merge-index is signaled to indicate which motion pair candidate in the candidate list is used.

At step 1070, the decoder derives, based on the set of motion pair candidates, at least two blending matrices associated with the coding block. Accordingly, the at least two blending matrices can be derived using the set of reordered motion pair candidates. In some cases, the two integer blending matrices of the pair (W0 and W1) can be derived from the template (1 line above, 1 column left).

Finally, at step 1080, the decoder applies the at least two blending matrices to at least two geometric partition parts of the coding block, respectively. In some cases, after each geometric partition part is predicted using its own motion, weighted blending is applied to the two predictions.

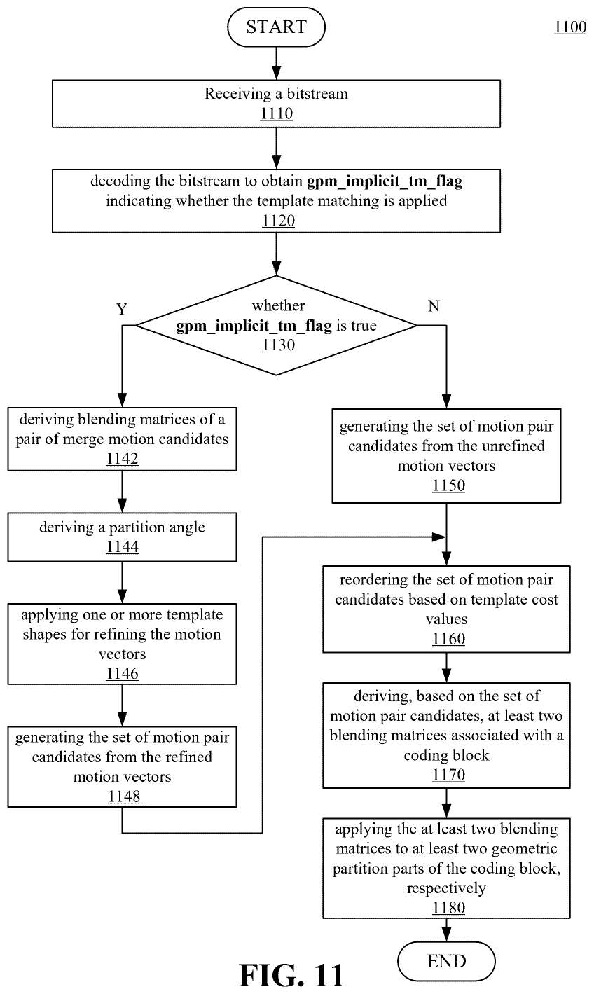

In some embodiments, the TM mode of implicit GPM can be designed as an explicit mode, and the template used to refine motion vectors includes only above neighboring samples, or only left neighboring samples, or both above and left neighboring samples. FIG. 11 is a flowchart for another example method 1100 for decoding a bitstream, according to some embodiments of the present disclosure. As shown in FIG. 11, the method 1100 includes the following steps 1110-1180.

At step 1110, the decoder receives a bitstream (e.g., video bitstream 228 in FIG. 3). The bitstream received from the encoder side includes one or more CUs of a video frame. At step 1120, after receiving the bitstream, the decoder may decode the bitstream to obtain a flag (e.g., gpm_implicit_tm_flag) indicating whether the template matching is applied. At step 1130, the decoder determines whether TM is applied to both geometric partitions.

In response to TM being applied to both geometric partitions (step 1130—Yes), gpm_implicit_tm_flag is true, the decoder performs steps 1142-1148 to generate the set of motion pair candidates. Specifically, before generating the set of motion pair candidates in step 1148, the decoder further performs steps 1142-1146. At step 1142, the two integer blending matrices of the pair of merge motion candidates are derived from the template constructed by neighboring samples (1 line above, 1 column left). Then, at step 1144, the partition angle is derived from the two integer blending matrices. Then, at step 1146, one or more template shapes (above, left, above and left) for refining motion vectors are applied to each geometric partition according to the mapping relationship in Table 2. In some embodiments, the motion vector is then refined by minimizing the difference between the current template and the template in the reference picture using the same search pattern of merge mode with half-pel interpolation filter disabled. Next, at step 1148, the set of motion pair candidates is built from the TM-refined motion candidates, instead of merge motion candidates.

The subsequent steps 1160-1180 are the same as steps 1060-1080 in method 1000 in FIG. 10. In response to gpm_implicit_tm_flag being false (step 1130—No), the subsequent steps 1150-1180 are the same as steps 1050-1080 in method 1000 in FIG. 10.

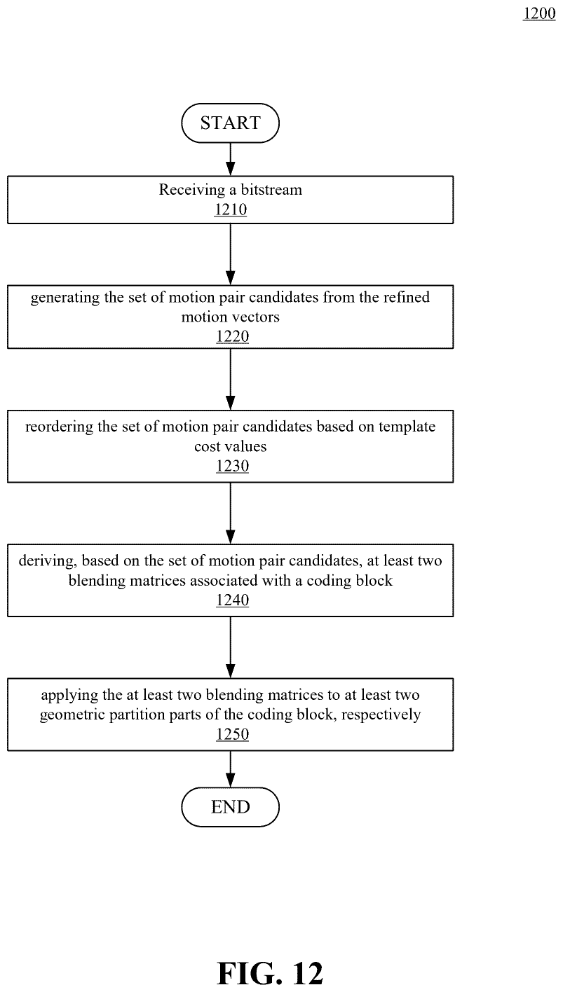

In some embodiments, the TM mode of implicit GPM is designed as an implicit mode, and TM-refinement is always performed. FIG. 12 is a flowchart for another example method 1200 for decoding a bitstream, according to some embodiments of the present disclosure. As shown in FIG. 12, the method 1200 includes the following steps 1210-1250.

At step 1210, the decoder receives a bitstream (e.g., video bitstream 228 in FIG. 3). The bitstream received from the encoder side includes one or more CUs of a video frame.

At step 1220, the decoder generates the set of motion pair candidates from the refined motion vectors. Detailed operations of step 1220 are similar to those described with respect to step 1040 and thus are omitted herein for the sake of brevity. The subsequent steps 1230-1250 are the same as steps 1060-1080 in method 1000 in FIG. 10, and thus details are not repeated herein for the sake of brevity.

In the embodiments shown in FIG. 12, when the implicit GPM mode is chosen, a template can be constructed using left and above neighboring samples. The motion vector is always refined by minimizing the difference between the current template and the template in the reference picture using the same search pattern of merge mode with half-pel interpolation filter disabled. Then, the list of motion pair candidates is built from the TM-refined motion candidates instead of merge motion candidates. The subsequent steps are the same as the original implicit GPM method.

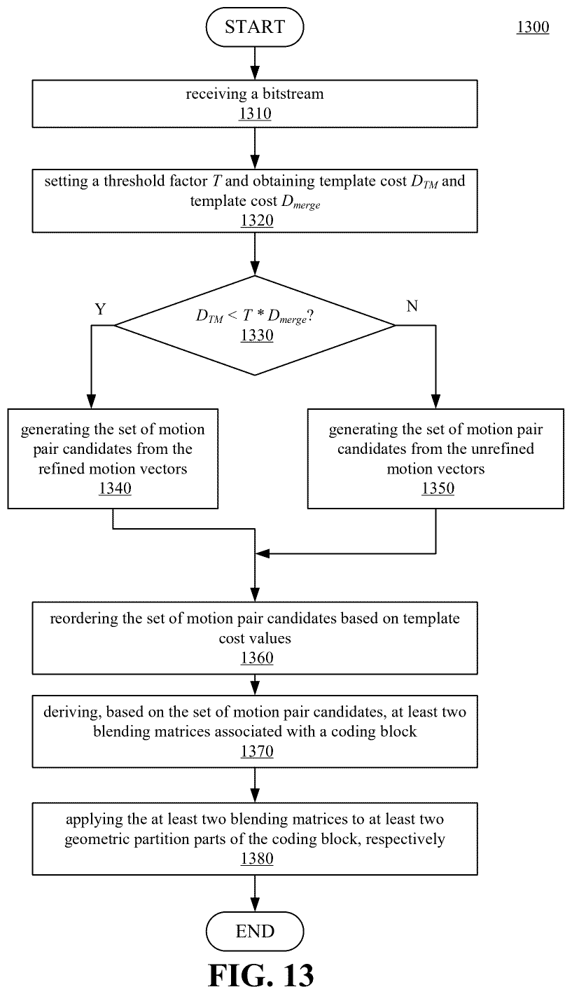

In some embodiments, the TM mode of implicit GPM is designed as an implicit mode, and TM-refinement is performed according to template cost. FIG. 13 is a flowchart for an example method 1300 for decoding a bitstream, according to some embodiments of the present disclosure. In the embodiments shown in FIG. 13, when the implicit GPM mode is chosen, a template can be constructed using left and above neighboring samples. As shown in FIG. 13, the method 1300 includes the following steps 1310-1380.

At step 1310, the decoder receives a bitstream (e.g., video bitstream 228 in FIG. 3). The bitstream received from the encoder side includes one or more CUs of a video frame.

At step 1320, the decoder sets a threshold factor T and obtains template costs D_{TM} and D_{merge}. In some embodiments, in order to ensure that the motion vector refined by TM is better than merge motion vector, the threshold factor T is set.

At step 1330, the decoder determines whether a first template cost associated with the refined motion vectors is equal to or greater than a second template cost associated with the merge motion vectors multiplied by a threshold factor. For example, the decoder may determine whether the template cost D_{TM} after TM refining is lower than the template cost D_{merge} of merge motion vector multiplied by the threshold factor T.

In response to the template cost D_{TM} being lower than the template cost D_{merge} multiplied by the threshold factor T (step 1330—Yes), the decoder performs step 1340 to generate the set of motion pair candidates from the refined motion vectors, and the subsequent steps 1360-1380 are the same as the steps 1060-1080 in method 1000 in FIG. 10.

In response to the template cost D_{TM} being equal to or greater than the template cost D_{merge} multiplied by the threshold factor T (step 1330—No), the decoder performs step 1350 to generate the set of motion pair candidates from the unrefined motion vectors (i.e., merge motion vectors) without using the refined motion vectors, and the subsequent steps 1360-1380 are the same as the steps 1060-1080 in method 1000 in FIG. 10.

Accordingly, in method 1300, when the template cost after TM refining is lower than the template cost of merge motion vector multiplied by the threshold factor, the refined motion vector is used in the motion compensation. When the template cost after TM refining is not lower than the template cost of merge motion vector multiplied by the threshold factor, the original merge motion vector is used in the motion compensation. Then the list of motion pair candidates is built from the processed motion candidates. The subsequent steps are the same as the original implicit GPM method. The condition of motion vector refined by TM as follows:

$${MV}_{processed} = \{ \begin{matrix}{MV}_{TM} , & {D}_{TM} < T * {D}_{merge} \\ {MV}_{merge} , & otherwise\end{matrix} \qquad ( Equation 13 )$$

where MV_{precessed}, MV_{TM}, MV_{merge} are motion vector of processed, TM refined and merge, respectively. D_{TM} and D_{merge} are the template cost of TM refined and merge. T is the threshold factor.

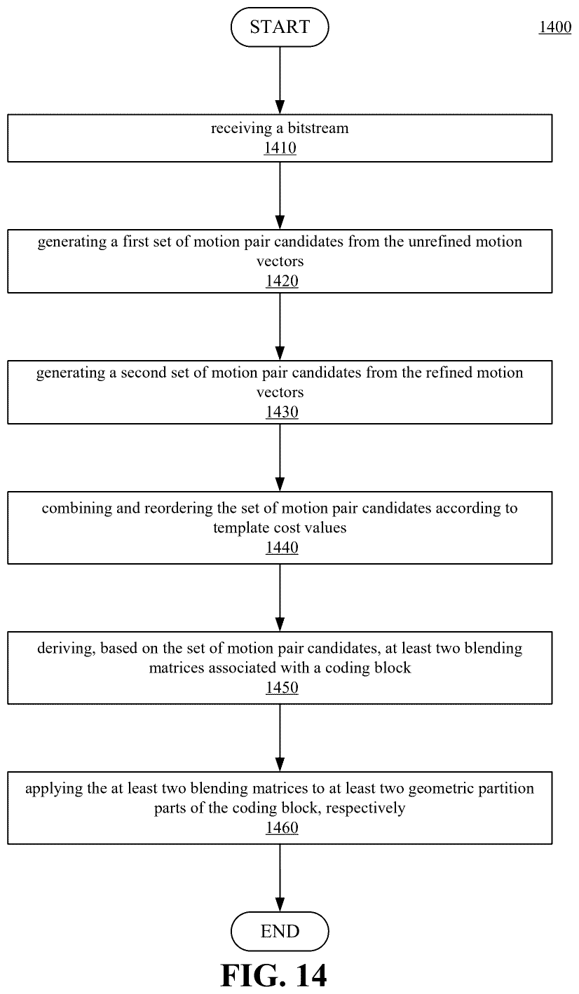

In some embodiments, the TM mode of implicit GPM can be designed as an implicit mode, and TM-refinement motion pair candidates compete with unrefined motion pair candidates according to their template costs. FIG. 14 is a flowchart for another example method 1400 for decoding a bitstream, according to some embodiments of the present disclosure. As shown in FIG. 14, the method 1400 includes the following steps 1410-1460.

At step 1410, the decoder receives a bitstream (e.g., video bitstream 228 in FIG. 3). The bitstream received from the encoder side includes one or more CUs of a video frame.

At step 1420, the decoder generates a first set of motion pair candidates from the unrefined motion vectors (i.e., merge motion vectors). At step 1430, the decoder generates a second set of motion pair candidates from the refined motion vectors. Detailed operations of steps 1420 and 1430 are similar to those described with respect to steps 1040 and 1050 and thus are omitted herein for the sake of brevity.

At step 1440, the decoder combines and reorders the first set and the second set of the motion pair candidates according to template cost values to obtain a combined list of the motion pair candidates. As shown in FIG. 14, when the implicit GPM mode is chosen, a template is constructed using left and above neighboring samples. The motion vector is refined by minimizing the difference between the current template and the template in the reference picture using the same search pattern of merge mode with half-pel interpolation filter disabled. Then two lists of motion pair candidates are built, one with TM-based refined motion vector pairs and the other with unrefined motion vector pairs. At step 1440, the decoder may compare the template cost in the two lists, and the motion pair candidate with lower template cost can be selected and put into a new combined list. The combined list of motion pair candidates can be used in the subsequent steps 1450 and 1460. The subsequent steps are the same as the steps 1070 and 1080 in method 1000 in FIG. 10, and thus details are not repeated herein for the sake of brevity.

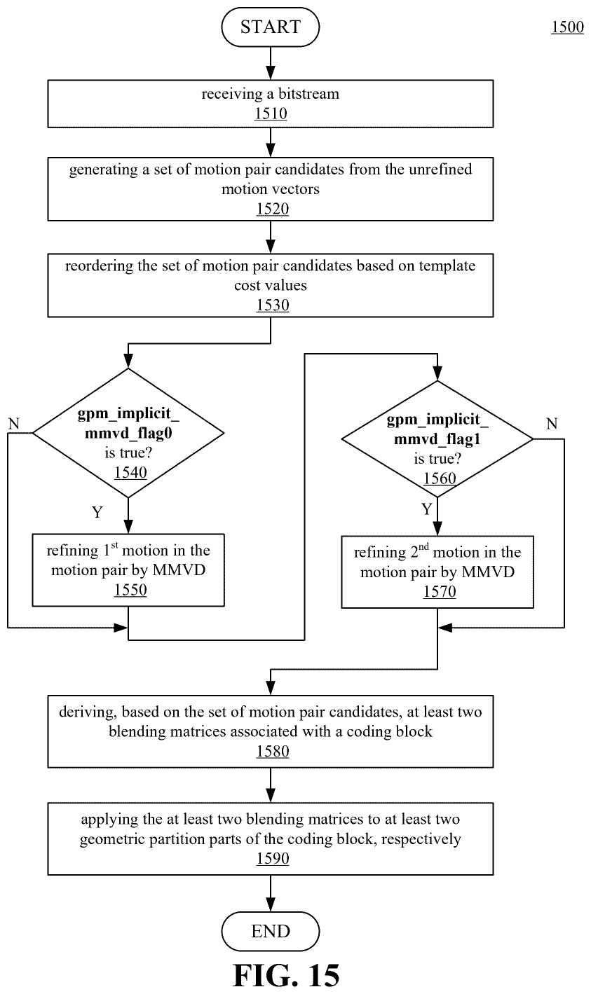

In some embodiments of the present disclosure, merge motion vector differences (MMVD) can be applied to implicit GPM. As shown in the following methods 1500-1700 in FIGS. 15-17, the decoder can refine the set of motion pair candidates by using merge motion vector differences (MMVD) in response to the flag indicating that MMVD is applied, before the decoder derives the at least two blending matrices associated with the coding block.

For example, in some embodiments, the MMVD mode of implicit GPM can be designed as an explicit mode, and two flags and two indices are signaled. FIG. 15 is a flowchart for another example method 1500 for decoding a bitstream, according to some embodiments of the present disclosure. In the method 1500, an MMVD mode is applied to the implicit GPM. As shown in FIG. 15, the method 1500 includes the following steps 1510-1590.

At step 1510, the decoder receives a bitstream (e.g., video bitstream 228 in FIG. 3). At step 1520, the decoder generates a set of motion pair candidates from the unrefined motion vectors. At step 1530, the decoder reorders the set of motion pair candidates based on template cost values. Detailed operations of steps 1520 and 1530 are similar to those described with respect to step 1050 and 1060 and thus are omitted herein for the sake of brevity.

In the embodiments shown in FIG. 15, when the implicit GPM mode is chosen, two CU-level flags (gpm_implicit_mmvd_flag0, gpm_implicit_mmvd_flag1) are signaled to indicate whether MMVD is applied to the first and second geometric partition, respectively. In other words, the decoder may decode a first flag (gpm_implicit_mmvd_flag0) indicating whether the MMVD is applied to a first geometric partition and a second flag (gpm_implicit_mmvd_flag1) indicating whether the MMVD is applied to a second geometric partition under the implicit geometric partitioning mode. In steps 1520 and 1530, the list of motion pair candidates is built from the merge motion candidates. Then, a merge-index is signaled to indicate which motion pair candidate in the candidate list is used.

At step 1540, the decoder determines whether MMVD is applied to the first geometric partition. In response to MMVD being applied to the first geometric partition (step 1540—Yes), gpm_implicit_mmvd_flag0 is true, the decoder performs step 1550.

When gpm_implicit_mmvd_flag0 is true, the motion vector difference (MVD) index is signaled by a first index gpm_implicit_mmvd_idx0. Then, at step 1550, the MVD is added to the motion vector of the first partition, and the decoder refines the motion vector of the first partition by MMVD.

In other words, in steps 1540 and 1550, in response to the first flag (e.g., gpm_implicit_mmvd_flag0) indicating the MMVD being applied to the first geometric partition, the decoder refines a first motion in one of the motion pair candidates based on a first motion vector difference (MVD) index (e.g., gpm_implicit_mmvd_idx0). In response to MMVD being not applied to the first geometric partition (step 1540—No), gpm_implicit_mmvd_flag0 is false, step 1550 is skipped, and the motion vector of the first partition is not refined by MVD.

Similarly, at step 1560, the decoder determines whether MMVD is applied to the second geometric partition. In response to MMVD being applied to the second geometric partition (step 1560—Yes), gpm_implicit_mmvd_flag1 is true, the decoder performs step 1570.

When gpm_implicit_mmvd_flag1 is true, the MVD index is signaled by gpm_implicit_mmvd_idx1. Then, at step 1570, MVD is added to the motion vector of the second partition, and the decoder refines the motion vector of the second partition by MMVD.

In other words, in steps 1560 and 1570, in response to the second flag (e.g., gpm_implicit_mmvd_flag1) indicating the MMVD being applied to the second geometric partition, the decoder refines a second motion in one of the motion pair candidates based on a second motion vector difference (MVD) index (e.g., gpm_implicit_mmvd_idx1). In response to MMVD being not applied to the second geometric partition (step 1560—No), gpm_implicit_mmvd_flag1 is false, step 1570 is skipped, the motion vector of the second partition is not refined by MVD.

The subsequent steps 1580 and 1590 are the same as steps 1070 and 1080 in method 1000 in FIG. 10. Accordingly, in the embodiments of FIG. 15, the motion vectors of two geometric partitions are refined by MVD independently.

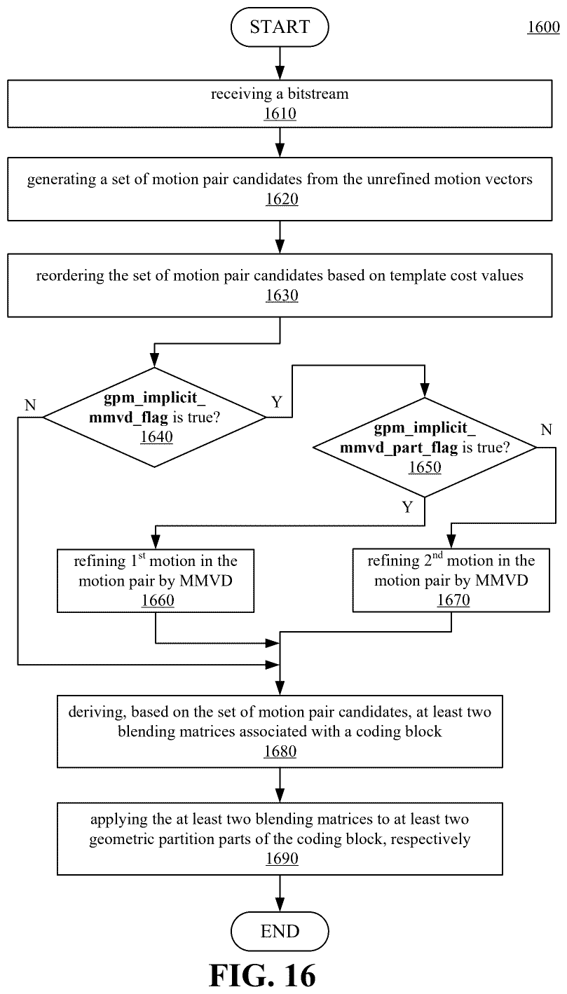

In some embodiments, the MMVD mode of implicit GPM can also be designed as an explicit mode, and two flags and one index are signaled. FIG. 16 is a flowchart for another example method 1600 for decoding a bitstream, according to some embodiments of the present disclosure. In the method 1600, an MMVD mode is applied to the implicit GPM. As shown in FIG. 16, the method 1600 includes the following steps 1610-1690.

Similar to steps 1510-1530 in the method 1500 of FIG. 15, at step 1610, the decoder receives a bitstream (e.g., video bitstream 228 in FIG. 3). At step 1620, the decoder generates a set of motion pair candidates from the unrefined motion vectors. At step 1630, the decoder reorders the set of motion pair candidates based on template cost values. Detailed operations of steps 1620 and 1630 are similar to those described above and thus are omitted herein for the sake of brevity.

In the embodiments shown in FIG. 16, when the implicit GPM mode is chosen, one CU-level flag (gpm_implicit_mmvd_flag) is signaled to indicate whether MMVD is applied to one of the geometric partitions. In steps 1620 and 1630, the list of motion pair candidates is built from the merge motion candidates. Then a merge-index is signaled to indicate which motion pair candidate in the candidate list is used.

At step 1640, the decoder determines whether gpm_implicit_mmvd_flag is true. When gpm_implicit_mmvd_flag is true (step 1640—Yes), a CU-level flag (gpm_implicit_mmvd_part_flag) is signaled to indicate the geometric partition of which the motion vector is refined by MMVD, and the MVD index is signaled by gpm_implicit_mmvd_idx to indicate the MVD value.

Then, at step 1650, the decoder determines whether gpm_implicit_mmvd_part_flag is true. When gpm_implicit_mmvd_part_flag is true (step 1650—Yes), at step 1660, the motion vector of the first partition is refined by the chosen MVD (i.e., the MVD is added to the motion vector of the first partition). When gpm_implicit_mmvd_part_flag is false (step 1650—No), at step 1670, the motion vector of the second partition is refined by the chosen MVD (i.e., the MVD is added to the motion vector of the first partition).

When gpm_implicit_mmvd_flag is false (step 1640—No), steps 1650-1670 are skipped, and the motion vector is not refined by MVD.

The subsequent steps 1680 and 1690 are the same as steps 1580 and 1590 in method 1500 in FIG. 15. Accordingly, in the embodiments of FIG. 16, the motion vector of only one of the two geometric partitions is refined by MVD.

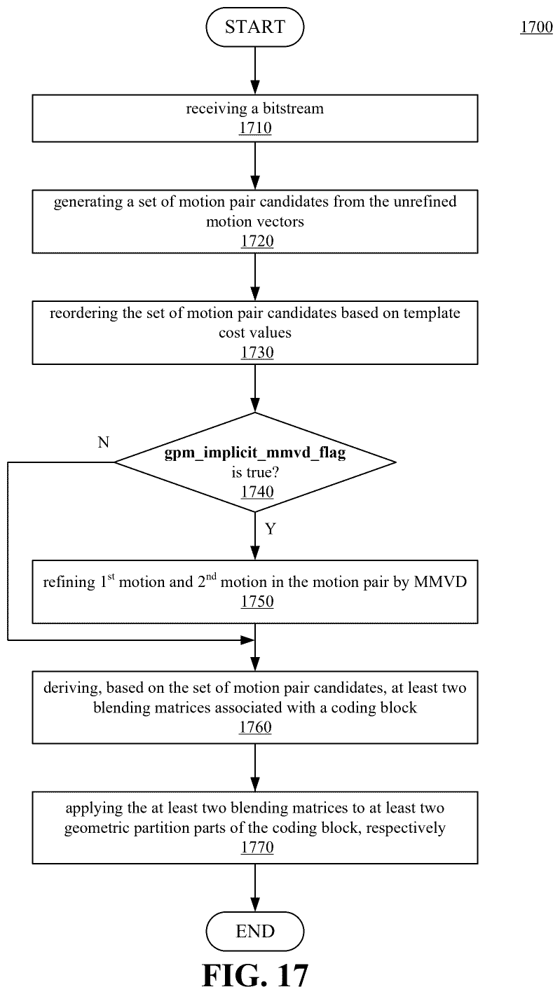

In some other embodiments, the MMVD mode of implicit GPM can be designed as an explicit mode, with one flag and one index being signaled. FIG. 17 is a flowchart for another example method 1700 for decoding a bitstream, according to some embodiments of the present disclosure. In the method 1700, an MMVD mode is also applied to the implicit GPM. As shown in FIG. 17, the method 1700 includes the following steps 1710-1770.

Similar to steps 1510-1530 and 1610-1630 in the methods 1500 and 1600 of FIGS. 15-16, at step 1710, the decoder receives a bitstream (e.g., video bitstream 228 in FIG. 3). At step 1720, the decoder generates a set of motion pair candidates from the unrefined motion vectors. At step 1730, the decoder reorders the set of motion pair candidates based on template cost values. Detailed operations of steps 1720 and 1730 are similar to those described above and thus are omitted herein for the sake of brevity.

As shown in FIG. 17, when the implicit GPM mode is chosen, a CU-level flag (gpm_implicit_mmvd_flag) is signaled to indicate whether MMVD is applied to both the geometric partitions. In steps 1720 and 1730, the list of motion pair candidates is built from the merge motion candidates. Then a merge-index is signaled to indicate which motion pair candidate in the candidate list is used.

At step 1740, the decoder determines whether gpm_implicit_mmvd_flag is true. When gpm_implicit_mmvd_flag is true (step 1740—Yes), the MVD index is signaled by gpm_implicit_mmvd_idx. Then, at step 1750, the first part and second part in the used motion pair candidate are both refined by the chosen MVD (i.e., the MVD is added to the motion vector of the first and second partitions). When gpm_implicit_mmvd_flag is false (step 1740—No), step 1750 is skipped, and the motion vector is not refined by MVD. In other words, in steps 1740 and 1750, the decoder decodes a flag (e.g., gpm_implicit_mmvd_flag) indicating whether the MMVD is applied to both a first and a second geometric partitions under the implicit geometric partitioning mode. In response to the flag indicating the MMVD being applied to the first and the second geometric partitions, the decoder refines both the first and the second motions in one of the motion pair candidates by the MMVD.

The subsequent steps 1760 and 1770 are the same as steps 1580 and 1590 in method 1500 in FIG. 15. In the embodiments of FIG. 17, the motion vectors of both geometric partitions are refined by MVD, or none of the motion vectors of two geometric partitions are refined by MVD.

Similar to the method 1000 in FIG. 10, the above methods 1100-1700 in FIGS. 11-17 can also be performed by a decoder (e.g., decoder 300 in FIG. 3) to decode video bitstream 228 in FIG. 3, and the decoder can be implemented as one or more software or hardware components of an apparatus (e.g., apparatus 400 in FIG. 4) for decoding the bitstream (e.g., video bitstream 228 in FIG. 3).

In addition, methods for encoding the bitstream corresponding to methods 1000-1700 in FIGS. 10-17 can be performed by an encoder (e.g., encoder 200 in FIG. 2) to generate video bitstream associated with the video frame. For example, the encoder can be implemented as one or more software or hardware components of an apparatus (e.g., apparatus 400 in FIG. 4) for encoding or transcoding a video sequence (e.g., video sequence 202 in FIG. 2) to generate the bitstream (e.g., video bitstream 228 in FIG. 2) for the video frame or the video sequence including one or more CUs. For example, a processor (e.g., processor 402 in FIG. 4) can perform the methods for encoding the bitstream.

For example, the encoder may perform an encoding method to perform encoding after receiving the video sequence to generate the video bitstream by determining that an implicit GPM is applied to a coding block, generating a set of motion pair candidates from refined MVs or merge MVs under an implicit GPM, deriving, based on the set of motion pair candidates, at least two blending matrices associated with the coding block, applying the at least two blending matrices to at least two geometric partition parts of the coding block, respectively, and encoding the at least two geometric partition parts. Thus, the video bitstream generated by the encoder using various encoding methods can be decoded by the decoder using decoding methods 1000-1700 by an inverse operation. Detailed operations of methods for encoding the bitstream are similar to those described above in the methods 1000-1700 for decoding the bitstream, and thus are omitted herein for the sake of brevity.

In some embodiments, both template matching (TM) and merge motion vector differences (MMVD) can be applied to implicit GPM. In various embodiments, the implicit GPM with TM mode can be an explicit mode or an implicit mode, and the implicit GPM with MMVD mode can be signaled by one flag and one index, two flags and one index, or two flags and two indexes. In some embodiments, the implicit GPM with TM mode and the implicit GPM with MMVD mode are exclusively enabled to one implicit GPM CU. One of ordinary skill in the art will also understand that multiple embodiments described above can be freely combined when appropriate.

For example, in some cases, the implicit GPM with TM can be an explicit mode, and the implicit GPM with MMVD signaled by two flags and two indexes. The implicit GPM with TM mode and the implicit with MMVD mode are exclusively enabled to one implicit GPM CU.

In some embodiments, when both two MMVD-refined control flags are equal to false, the TM-refined control flag is signaled. When at least one of the two MMVD-refined control flags is equal to true, the TM-refined control flag is not signaled. In some other embodiments, when TM-refined control flag is equal to false, the MMVD-refined control flags are signaled. When TM-refined control flag is equal to true, the MMVD-refined control flags are not signaled.

In some other cases, the implicit GPM with TM can be an explicit mode, and the implicit GPM with MMVD signaled by two flags and one index. The implicit GPM with TM mode and the implicit with MMVD mode are exclusively enabled to one implicit GPM CU.

In some embodiments, when the MMVD-refined control flag is equal to false, the TM-refined control flag is signaled. When the MMVD-refined control flag is equal to true, the TM-refined control flag is not signaled. In some other embodiments, when TM-refined control flag is equal to false, the MMVD-refined control flag is signaled. When TM-refined control flag is equal to false, the MMVD-refined control flag is not signaled.

In yet some other cases, the implicit GPM with TM can be an explicit mode, and the implicit GPM with MMVD signaled by one flag and one index. The implicit GPM with TM mode and the implicit with MMVD mode are exclusively enabled to one implicit GPM CU.

In some embodiments, when the MMVD-refined control flag is equal to false, the TM-refined control flag is signaled. When the MMVD-refined control flag is equal to true, the TM-refined control flag is not signaled. In some other embodiments, when TM-refined control flag is equal to false, the MMVD-refined control flag is signaled. When TM-refined control flag is equal to false, the MMVD-refined control flag is not signaled.

In yet some other cases, the implicit GPM with TM can be an implicit mode, and the implicit GPM with MMVD signaled by two flags and two indexes. The implicit GPM with TM mode and the implicit with MMVD mode are exclusively enabled to one implicit GPM CU. When both two MMVD-refined control flags are equal to false, the TM-refined is enabled. When at least one of the two MMVD-refined control flags are equal to true, the TM-refined is disabled.

In yet some other cases, the implicit GPM with TM is an explicit mode, and the implicit GPM with MMVD signaled by two flags and one index. The implicit GPM with TM mode and the implicit with MMVD mode are exclusively enabled to one implicit GPM CU. When the MMVD-refined control flag is equal to false, the TM-refined is enabled. When the MMVD-refined control flag is equal to true, the TM-refined is disabled.

In yet some other cases, the implicit GPM with TM is an explicit mode, and the implicit GPM with MMVD signaled by one flag and one index. The implicit GPM with TM mode and the implicit with MMVD mode are exclusively enabled to one implicit GPM CU. When the MMVD-refined control flag is equal to false, the TM-refined is enabled. When the MMVD-refined control flag is equal to true, the TM-refined is disabled.

In some embodiments, a non-transitory computer-readable storage medium storing a bitstream is also provided. The bitstream can be encoded and decoded according to the above-described methods. As explained above, the bitstream can be generated based on an input video sequence, and stored in a non-transitory computer-readable storage medium. The bitstream stored in the non-transitory computer-readable storage medium includes coded information associated with at least two geometric partition parts of the coding block. A method of storing a bitstream may include operations of determining that an implicit GPM is applied to a coding block, generating a set of motion pair candidates from refined MVs obtained by template matching or merge MVs under an implicit GPM, deriving, based on the set of motion pair candidates, at least two blending matrices associated with the coding block, applying the at least two blending matrices to at least two geometric partition parts of the coding block, respectively, generating a bitstream including coded information associated with the at least two geometric partition parts; and storing the bitstream in a non-transitory computer readable storage medium.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A method for decoding a bitstream, the method comprising:
receiving a bitstream; and
decoding the bitstream to output a video sequence, the decoding comprising:
generating a set of motion pair candidates from refined motion vectors or merge motion vectors under an implicit geometric partitioning mode, wherein the refined motion vectors are obtained by template matching;
deriving, based on the set of motion pair candidates, at least two blending matrices associated with a coding block; and
applying the at least two blending matrices to at least two geometric partition parts of the coding block, respectively.

2. The method according to clause 1, further comprising:
determining whether the template matching is applied to two geometric partitions in the coding block; and
in response to the template matching being applied to the two geometric partitions, generating the set of motion pair candidates from the refined motion vectors.

3. The method according to clause 1 or 2, further comprising:
in response to the template matching being applied to the two geometric partitions, before generating the set of motion pair candidates:
deriving at least two integer blending matrices of a pair of merge motion candidates from a template constructed by neighboring samples;
deriving a partition angle from the at least two integer blending matrices; and
applying one or more template shapes for refining the motion vectors to each geometric partition.

4. The method according to any of clauses 1-3, further comprising:
reordering the set of motion pair candidates based on template cost values associated with the motion pair candidates, wherein the at least two blending matrices are derived using the set of reordered motion pair candidates.

5. The method according to any of clauses 1-4, further comprising:
determining whether a first template cost associated with the refined motion vectors is equal to or greater than a second template cost associated with the merge motion vectors multiplied by a threshold factor; and
in response to the first template cost being equal to or greater than the second template cost multiplied by the threshold factor, generating the set of motion pair candidates from the merge motion vectors without using the refined motion vectors.

6. The method according to any of clauses 1-5, further comprising:
generating a first set of the motion pair candidates from the merge motion vectors;
generating a second set of the motion pair candidates from the refined motion vectors; and
combining and reordering the first list and the second list of the motion pair candidates according to template cost values to obtain a combined list of the motion pair candidates, wherein the at least two blending matrices are derived using the combined list of the motion pair candidates.

7. The method according to any of clauses 1-6, further comprising:
refining the set of motion pair candidates by using merge motion vector differences (MMVD) before deriving the at least two blending matrices.

8. The method according to claim 7, further comprising:
decoding a first flag indicating whether the MMVD is applied to a first geometric partition and a second flag indicating whether the MMVD is applied to a second geometric partition under the implicit geometric partitioning mode;
in response to the first flag indicating the MMVD being applied to the first geometric partition, refining a first motion in one of the motion pair candidates based on a first motion vector difference (MVD) index; and
in response to the second flag indicating the MMVD being applied to the second geometric partition, refining a second motion in the one of the motion pair candidates based on a second motion vector difference (MVD) index.

9. The method according to clause 7 or 8, further comprising:
decoding a flag indicating whether the MMVD is applied to a first geometric partition and a second geometric partition under the implicit geometric partitioning mode; and
in response to the flag indicating the MMVD being applied to the first geometric partition and the second geometric partition, refining both a first motion and a second motion in one of the motion pair candidates by the MMVD.

10. A method for encoding a video sequence, the method comprising:
receiving a video sequence; and
encoding the video sequence by:
   determining that an implicit geometric partitioning mode is applied to a coding block;
   generating a set of motion pair candidates from refined motion vectors or merge motion vectors under an implicit geometric partitioning mode, wherein the refined motion vectors are obtained by template matching;
   deriving, based on the set of motion pair candidates, at least two blending matrices associated with the coding block;
   applying the at least two blending matrices to at least two geometric partition parts of the coding block, respectively; and
   encoding the at least two geometric partition parts.

11. The method according to clause 10, further comprising:
determining whether the template matching is applied to two geometric partitions in the coding block; and
in response to the template matching being applied to the two geometric partitions, generating the set of motion pair candidates from the refined motion vectors.

12. The method according to clause 10 or 11, further comprising:
in response to the template matching being applied to the two geometric partitions, before generating the set of motion pair candidates:
deriving at least two integer blending matrices of a pair of merge motion candidates from a template constructed by neighboring samples;
deriving a partition angle from the at least two integer blending matrices; and
applying one or more template shapes for refining the motion vectors to each geometric partition.

13. The method according to any of clauses 10-12, further comprising:
reordering the set of motion pair candidates based on template cost values associated with the motion pair candidates, wherein the at least two blending matrices are derived using the set of reordered motion pair candidates.

14. The method according to any of clauses 10-13, further comprising:
determining whether a first template cost associated with the refined motion vectors is equal to or greater than a second template cost associated with the merge motion vectors multiplied by a threshold factor; and
in response to the first template cost being equal to or greater than the second template cost multiplied by the threshold factor, generating the set of motion pair candidates from the merge motion vectors without using the refined motion vectors.

15. The method according to any of clauses 10-14, further comprising:
generating a first list of the motion pair candidates from the refined motion vectors;
generating a second list of the motion pair candidates from the merge motion vectors; and
combining and reordering the first list and the second list of the motion pair candidates according to template cost values associated with the motion pair candidates to obtain a combined list of the motion pair candidates, wherein the at least two blending matrices are derived using the combined list of the motion pair candidates.

16. The method according to any of clauses 10-15, further comprising:
refining the set of motion pair candidates by using merge motion vector differences (MMVD) before deriving the at least two blending matrices.

17. The method according to clause 16, further comprising:
encoding a first flag indicating whether the MMVD is applied to a first geometric partition and a second flag indicating whether the MMVD is applied to a second geometric partition under the implicit geometric partitioning mode, wherein:
in response to the first flag indicating the MMVD being applied to the first geometric partition, a first motion in one of the motion pair candidates is refined based on a first motion vector difference (MVD) index; and
in response to the second flag indicating the MMVD being applied to the second geometric partition, a second motion in the one of the motion pair candidates is refined based on a second motion vector difference (MVD) index.

18. The method according to clause 16 or 17, further comprising:
encoding a flag indicating whether the MMVD is applied to a first geometric partition and a second geometric partition under the implicit geometric partitioning mode;
wherein in response to the flag indicating the MMVD being applied to the first geometric partition and the second geometric partition, a first motion and a second motion in one of the motion pair candidates are both refined by the MMVD based on a motion vector difference (MVD) index.

19. A method of storing a bitstream, the method comprising:
determining that an implicit geometric partitioning mode is applied to a coding block;
generating a set of motion pair candidates from refined motion vectors or merge motion vectors under an implicit geometric partitioning mode, wherein the refined motion vectors are obtained by template matching;
deriving, based on the set of motion pair candidates, at least two blending matrices associated with the coding block;
applying the at least two blending matrices to at least two geometric partition parts of the coding block, respectively;
generating a bitstream comprising coded information associated with the at least two geometric partition parts; and
storing the bitstream in a non-transitory computer readable storage medium.

20. The method of claim 19, further comprising:
determining whether the template matching is applied to two geometric partitions in the coding block when the implicit geometric partitioning mode is enabled; and
in response to the template matching being applied to the two geometric partitions, generating the set of motion pair candidates from the refined motion vectors.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for decoding a bitstream, the method comprising:
receiving a bitstream; and
decoding the bitstream to output a video sequence, the decoding comprising:
generating a set of motion pair candidates from refined motion vectors or merge motion vectors under an implicit geometric partitioning mode, wherein the refined motion vectors are obtained by template matching;
deriving, based on the set of motion pair candidates, at least two blending matrices associated with a coding block; and
applying the at least two blending matrices to at least two geometric partition parts of the coding block, respectively.

2. The method according to claim 1, further comprising:
determining whether the template matching is applied to two geometric partitions in the coding block; and
in response to the template matching being applied to the two geometric partitions, generating the set of motion pair candidates from the refined motion vectors.

3. The method according to claim 1, further comprising:
in response to the template matching being applied to the two geometric partitions, before generating the set of motion pair candidates:
deriving at least two integer blending matrices of a pair of merge motion candidates from a template constructed by neighboring samples;
deriving a partition angle from the at least two integer blending matrices; and
applying one or more template shapes for refining the motion vectors to each geometric partition.

4. The method according to claim 1, further comprising:
reordering the set of motion pair candidates based on template cost values associated with the motion pair candidates, wherein the at least two blending matrices are derived using the set of reordered motion pair candidates.

5. The method according to claim 1, further comprising:
determining whether a first template cost associated with the refined motion vectors is equal to or greater than a second template cost associated with the merge motion vectors multiplied by a threshold factor; and
in response to the first template cost being equal to or greater than the second template cost multiplied by the threshold factor, generating the set of motion pair candidates from the merge motion vectors without using the refined motion vectors.

6. The method according to claim 1, further comprising:
generating a first set of the motion pair candidates from the merge motion vectors;
generating a second set of the motion pair candidates from the refined motion vectors; and
combining and reordering the first list and the second list of the motion pair candidates according to template cost values to obtain a combined list of the motion pair candidates, wherein the at least two blending matrices are derived using the combined list of the motion pair candidates.

7. The method according to claim 1, further comprising:
refining the set of motion pair candidates by using merge motion vector differences (MMVD) before deriving the at least two blending matrices.

8. The method according to claim 7, further comprising:
decoding a first flag indicating whether the MMVD is applied to a first geometric partition and a second flag indicating whether the MMVD is applied to a second geometric partition under the implicit geometric partitioning mode;
in response to the first flag indicating the MMVD being applied to the first geometric partition, refining a first motion in one of the motion pair candidates based on a first motion vector difference (MVD) index; and
in response to the second flag indicating the MMVD being applied to the second geometric partition, refining a second motion in the one of the motion pair candidates based on a second motion vector difference (MVD) index.

9. The method according to claim 7, further comprising:
decoding a flag indicating whether the MMVD is applied to a first geometric partition and a second geometric partition under the implicit geometric partitioning mode; and
in response to the flag indicating the MMVD being applied to the first geometric partition and the second geometric partition, refining both a first motion and a second motion in one of the motion pair candidates by the MMVD.

10. A method for encoding a video sequence, the method comprising:
receiving a video sequence; and
encoding the video sequence by:
determining that an implicit geometric partitioning mode is applied to a coding block;
generating a set of motion pair candidates from refined motion vectors or merge motion vectors under an implicit geometric partitioning mode, wherein the refined motion vectors are obtained by template matching;
deriving, based on the set of motion pair candidates, at least two blending matrices associated with the coding block;
applying the at least two blending matrices to at least two geometric partition parts of the coding block, respectively; and
encoding the at least two geometric partition parts.

11. The method according to claim 10, further comprising:
determining whether the template matching is applied to two geometric partitions in the coding block; and
in response to the template matching being applied to the two geometric partitions, generating the set of motion pair candidates from the refined motion vectors.

12. The method according to claim 10, further comprising:
in response to the template matching being applied to the two geometric partitions, before generating the set of motion pair candidates:
deriving at least two integer blending matrices of a pair of merge motion candidates from a template constructed by neighboring samples;
deriving a partition angle from the at least two integer blending matrices; and
applying one or more template shapes for refining the motion vectors to each geometric partition.

13. The method according to claim 10, further comprising:
reordering the set of motion pair candidates based on template cost values associated with the motion pair candidates, wherein the at least two blending matrices are derived using the set of reordered motion pair candidates.

14. The method according to claim 10, further comprising:
determining whether a first template cost associated with the refined motion vectors is equal to or greater than a second template cost associated with the merge motion vectors multiplied by a threshold factor; and
in response to the first template cost being equal to or greater than the second template cost multiplied by the threshold factor, generating the set of motion pair candidates from the merge motion vectors without using the refined motion vectors.

15. The method according to claim 10, further comprising:
generating a first list of the motion pair candidates from the refined motion vectors;
generating a second list of the motion pair candidates from the merge motion vectors; and
combining and reordering the first list and the second list of the motion pair candidates according to template cost values associated with the motion pair candidates to obtain a combined list of the motion pair candidates, wherein the at least two blending matrices are derived using the combined list of the motion pair candidates.

16. The method according to claim 10, further comprising:
refining the set of motion pair candidates by using merge motion vector differences (MMVD) before deriving the at least two blending matrices.

17. The method according to claim 16, further comprising:
encoding a first flag indicating whether the MMVD is applied to a first geometric partition and a second flag indicating whether the MMVD is applied to a second geometric partition under the implicit geometric partitioning mode, wherein:
in response to the first flag indicating the MMVD being applied to the first geometric partition, a first motion in one of the motion pair candidates is refined based on a first motion vector difference (MVD) index; and
in response to the second flag indicating the MMVD being applied to the second geometric partition, a second motion in the one of the motion pair candidates is refined based on a second motion vector difference (MVD) index.

18. The method according to claim 16, further comprising:
encoding a flag indicating whether the MMVD is applied to a first geometric partition and a second geometric partition under the implicit geometric partitioning mode;
wherein in response to the flag indicating the MMVD being applied to the first geometric partition and the second geometric partition, a first motion and a second motion in one of the motion pair candidates are both refined by the MMVD based on a motion vector difference (MVD) index.

19. A method of storing a bitstream, the method comprising:
determining that an implicit geometric partitioning mode is applied to a coding block;
generating a set of motion pair candidates from refined motion vectors or merge motion vectors under an implicit geometric partitioning mode, wherein the refined motion vectors are obtained by template matching;
deriving, based on the set of motion pair candidates, at least two blending matrices associated with the coding block;
applying the at least two blending matrices to at least two geometric partition parts of the coding block, respectively;
generating a bitstream comprising coded information associated with the at least two geometric partition parts; and
storing the bitstream in a non-transitory computer readable storage medium.

20. The method of claim 19, further comprising:
determining whether the template matching is applied to two geometric partitions in the coding block when the implicit geometric partitioning mode is enabled; and
in response to the template matching being applied to the two geometric partitions, generating the set of motion pair candidates from the refined motion vectors.
